(19) United States
(12) Patent Application Publication
(10) Pub. No.: US 2017/0145839 A1
(43) Pub. Date: May 25, 2017

(54) TRANSITION DUCT SYSTEM WITH A ROBUST CONVERGING FLOW JOINT AT AN INTERSECTION BETWEEN ADJACENT TRANSITIONS EXTENDING BETWEEN A COMBUSTOR AND A TURBINE ASSEMBLY IN A GAS TURBINE ENGINE

(71) Applicant: Siemens Energy, Inc., Orlando, FL (US)

(72) Inventor: Jacob William Hardes, Charlotte, NC (US)

(21) Appl. No.: 15/309,472

(22) PCT Filed: Jun. 17, 2014
(86) PCT No.: PCT/US2014/042601

§ 371 Date: Nov. 8, 2016

(51) Int. Cl. F01D 9/02; F01D 5/02; F02C 3/14

(52) U.S. Cl. CPC F01D 9/023; F02C 3/14; F01D 5/02; F05D 2220/32; F05D 2240/35; F05D 2250/314

(57) ABSTRACT

A transition duct system (110) for routing a combustion exhaust gas flow from a combustor (112) to the first stage (114) of a turbine section (116) in a combustion turbine engine (118) is disclosed, whereby the system (110) imparts a circumferential vector to the combustion exhaust gases expelled from the system (110), thereby negating the need for a conventional row one vane assembly. The transition duct system (110) may include a robust converging flow joint between adjacent transition ducts (122, 124) within the system (110) such that adjacent transition sections (116) may be adjoined to each other via an intersection (126) forming a linear edge (128) which provides for a strong robust intersection (126) between the adjacent transition sections (116). In at least one embodiment, the linear edge (128) at the intersection (126) may be within 10 degrees of being orthogonal to an inner edge (130) of the transition sections (116) at the intersection (126).

### STATEMENT REGARDING FEDERALLY SPONSORED RESEARCH OR DEVELOPMENT

Development of this invention was supported in part by the United States Department of Energy, Advanced Turbine Development Program, Contract No. DE-FC26-05NT42644. Accordingly, the United States Government may have certain rights in this invention.

### FIELD OF THE INVENTION

This invention is directed generally to gas turbine engines, and more particularly to transition ducts for routing gas flow from combustors to the turbine section of gas turbine engines.

### BACKGROUND OF THE INVENTION

In conventional gas turbine engines, as shown in FIG. 1, combustion gases created within a combustor 10 are passed to a turbine assembly via a plurality of transition ducts 12. In many conventional systems, the transition ducts 12 extended longitudinally without any offset in a circumferential direction. A row of first stage vanes 14 were used to turn the combustion exhaust gases before being passed to the row one turbine blades 16. The use of first stage vanes 14 in a turbine assembly to accelerate and turn the longitudinal combustor exhaust gas flow in the circumferential direction presented several challenges. The vanes 14 and the associated vane support structures were required to have high strength characteristics to withstand the forces generated in changing the direction of extremely hot, high pressure gas flow over a substantial angle in a relatively short distance. The temperature of the gas flow and the heat generated by this turning process also require a vane cooling system. The forces and heat involved diminished material properties causing cracks to develop and otherwise damage the vanes and associated support structures.

To accommodate these operating conditions and to provide a more robust design, as shown in FIGS. 2-9, the transition ducts 20 directing combustion gases from a combustor 22 to a turbine assembly 24 were skewed circumferentially such that the outlets 26 of the transition ducts 20 were skewed circumferentially in the same direction of that the first row turbine vanes would otherwise skew the combustion exhaust gases in the circumferential direction. As such, row one turbine vanes were no longer needed because the exhaust gases emitted from the transition ducts 20 already included the correct circumferential vector, thereby eliminating the need for the row one turbine vanes. As shown in U.S. Pat. No. 8,113,003, filing date Aug. 12, 2008, issuance date Feb. 14, 2012, which is incorporated herein in its entirety, the outlet of each transition duct is skewed in the circumferential direction relative to the inlet of each transition duct. While the transition duct system of the U.S. Pat. No. 8,113,003 has eliminated the need for row one turbine vanes upstream of row one turbine blades within a turbine assembly, there exists a need to increase the useful life of the skewed transition duct system by eliminating areas of high stress, which are shown in FIGS. 6-9.

### SUMMARY OF THE INVENTION

A transition duct system for routing a combustion exhaust gas flow from a combustor to a first stage of a turbine section in a combustion turbine engine is disclosed, whereby the system imparts a circumferential vector to the combustion exhaust gases expelled from the system, thereby negating the need for a conventional row one vane assembly. The transition duct system may include a robust converging flow joint between adjacent transition ducts within the system such that adjacent transition sections may be adjoined to each other via an intersection forming a linear edge which provides for a strong robust intersection between the adjacent transition sections. In at least one embodiment, the linear edge at the intersection may be within 10 degrees of being orthogonal to an inner edge of the transition sections at the intersection.

The transition duct system is not limited to a particular configuration of the one or more transition duct bodies but may have any appropriate configuration enabling forming of a robust intersection formed from the linear edge formed at the intersection between side walls of two adjacent transition ducts. As such, the configuration of the transition duct body between the inlet and the outlet may have any appropriate configuration, confined only by the optimization targets of the design, which may include, but are not limited to being, guide points along the transition duct body to establish a desired throat area within the transition duct body, control clearance between adjacent ducts, minimize inflection points along the transition duct body, and achieve a smooth, streamwise surface curvature within the transition duct body.

In at least one embodiment, the transition duct system for routing gas flow in a combustion turbine subsystem including a first stage blade array having a plurality of blades extending in a radial direction from a rotor assembly for rotation in a circumferential direction, said circumferential direction having a tangential direction component, an axis of the rotor assembly defining a longitudinal direction, and at least one combustor located longitudinally upstream of the first stage blade array and located radially outboard of the first stage blade array, is disclosed. The transition duct system may include a first transition duct body having an internal passage extending between an inlet and an outlet. The outlet may be offset from the inlet in the longitudinal direction and the tangential direction. The outlet may be formed from a radially outer side generally opposite to a radially inner side, and the radially outer and inner sides may be coupled together with opposed first and second side walls. The second transition duct body may have an internal passage extending between an inlet and an outlet. The outlet may be offset from the inlet in the longitudinal direction and the tangential direction. The outlet may be formed from a radially outer side generally opposite to a radially inner side, and the radially outer and inner sides may be coupled together with opposed first and second side walls. The first side wall of the first transition duct body may terminate at an intersection with the second side wall of the second transition duct body, wherein the intersection forms a linear edge that may be offset from a line extending radially outward from the axis of the rotor assembly defining a longitudinal direction less than 35 degrees when viewed upstream along the axis of the rotor assembly defining a longitudinal direction.

In another embodiment, the intersection between the first side wall of the first transition duct body and the second side wall of the second transition duct body forms the linear edge that may be offset from the line extending radially outward from the axis of the rotor assembly defining a longitudinal direction less than 10 degrees when viewed upstream along the axis of the rotor assembly defining a longitudinal direction. In yet another embodiment, the intersection between the first side wall of the first transition duct body and the second side wall of the second transition duct body forms the linear edge may be aligned with the line extending radially outward from the axis of the rotor assembly defining a longitudinal direction. The intersection between the first side wall of the first transition duct body and the second side wall of the second transition duct body may form the linear edge extending orthogonally radially outward from an intersection created between the first side wall of the first transition duct body and the radially inner side of the first transition duct body. In yet another embodiment, the first side wall of the first transition duct body and the second side wall of the second transition duct body may be coplanar at the linear edge formed at the intersection between first side wall of the first transition duct body and the second side wall of the second transition duct body.

The transition duct system may also be configured such that the first side wall of the first transition duct body and the second side wall of the second transition duct body, when viewed radially inward and orthogonal to the axis of the rotor assembly defining the longitudinal direction, may be offset less than 15 degrees from each other. In another embodiment, the first side wall of the first transition duct body and the second side wall of the second transition duct body, when viewed radially inward and orthogonal to the axis of the rotor assembly defining the longitudinal direction, may be offset less than 5 degrees from each other. The radially inner side of the first transition duct body may intersect with the radially inner side of the second transition duct body at the linear edge at the intersection between the first side wall of the first transition duct body and the second side wall of the second transition duct body.

The transition duct system is not limited to a particular configuration of the one or more transition duct bodies but may have any appropriate configuration enabling formation of the linear edge at the intersection between side walls of two adjacent transition ducts. As such, the inlet of the first transition duct body may be cylindrical and wherein the first transition duct body transitions from a generally cylindrical inlet to a four sided outlet. The outlet of the first transition duct body may be formed from a curved radially inner side, a curved radially outer side, a radially extending, linear first side wall and a radially extending, linear second side wall. The outlet of the first transition duct body may be nonorthogonal and nonparallel to the inlet. The radially inner side of the first transition duct body may change orientations between the inlet and outlet. The radially outer side of the first transition duct body may change orientations between the inlet and outlet. The second transition duct body may be similarly or differently configured.

An advantage of the transition duct system is that the intersection between adjacent transition ducts that impart a circumferential vector to the downstream flowing combustion gases from the outlets is formed from a linear edge at the intersection between adjacent transition ducts, which increases the robustness of the intersection, thereby increasing the strength of the converging flow joint between the adjacent transition ducts.

Another advantage of the transition duct system is that the configuration of the adjacent transition duct bodies between the inlets and outlets is not limited to a particular configuration, shape and alignment, other than the cross-sectional flow area requirement to provide sufficient flow capacity. As such, the transition duct bodies between the inlets and outlets may have outer sides that are curved, change orientation about a longitudinal axis, increase in size, decrease in size and the like to best accommodate the linear edge at the intersection between adjacent transition ducts and to create efficiency in the combustion exhaust gas flow.

Still another advantage of the transition duct system is that the transition ducts impart a circumferential vector to the downstream flowing combustion gases from the outlets, thereby eliminating the necessity of row one turbine vanes and the inefficiencies associated with the row one turbine vanes.

Another advantage of the transition duct system is that the transition eliminates the need for row one turbine vanes and thus eliminates the leading and trailing edges, and the associated problems, including the difficulties of cooling the leading and trailing edges, and the gas blockage caused by the existence of the row one turbine vanes.

Yet another advantage of the transition duct system is that the transition duct eliminates leakages that exist between conventional transitions and turbine vanes because such connection does not exist.

Another advantage of the transition duct system is that the transition duct eliminates leakage between adjacent turbine vanes at the exit frame because the transition duct eliminates the need for row one turbine vanes.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a cross-sectional view of a portion of a gas turbine engine.

FIG. 2 is a downstream facing perspective view of an upper half of a plurality of can-annular combustors coupled to transition ducts.

FIG. 3 is an upstream longitudinal view of a circular array of transition ducts.

FIG. 4 is a side view of a transition duct relative to row one turbine blades.

FIG. 5 is a top view of a circular array of transition ducts.

FIG. 6 is a top view of a fitting in which two adjacent transition ducts are positioned.

FIG. 7 is a cross-sectional view of the two adjacent transition ducts of FIG. 6 taken along section line 7-7 in FIG. 6 in which an area of high mechanical stress is identified.

FIG. 8 is a perspective detailed view of the area of high mechanical stress at the intersection between the adjacent transition ducts taken along detail line 8-8 in FIG. 7.

FIG. 9 is another perspective view of the area of high mechanical stress at the intersection between the adjacent transition ducts taken along detail line 8-8 shown in FIG. 7.

FIG. 10 is a perspective view in an upstream direction of an intersection between adjacent conventional transition ducts.

FIG. 11 is a downstream facing perspective view of an upper half of a plurality of can-annular combustors coupled to transition ducts of the transition duct system.

FIG. 12 is an upstream longitudinal view of a circular array of transition ducts of the transition duct system.

FIG. 13 is a side view of a transition duct of the transition duct system relative to row one turbine blades.

FIG. 14 is a perspective view in an upstream direction of an intersection between adjacent transition ducts of the transition duct system.

FIG. 15 is a perspective view in an upstream direction of an intersection between adjacent transition ducts of the transition duct system having an alternative configuration of the relationship of the intersection of the adjacent transition ducts relative to a line extending radially outward from the axis of the rotor assembly.

FIG. 16 is a perspective view in an upstream direction of a transition duct of the transition duct system.

FIG. 17 is a perspective view of the transition ducts of the transition duct system assembly together.

FIG. 18 is an upstream view of a transition duct of the transition duct system, taken along section line 18-18 in FIG. 17.

FIG. 19 is another upstream view of a transition duct of the transition duct system, taken along section line 18-18 in FIG. 17, and having an different internal shape than shown in FIG. 18.

FIG. 20 is a perspective view of a transition duct of the transition duct system with cross-sectional areas graphical represented below each slice depicted in the transition duct.

FIG. 21 is a partial perspective view of two adjacent transition ducts looking upstream into the internal passageways of the transition ducts showing how the adjacent transition ducts next together at the exhaust outlets, with a first side wall of the first transition duct being coplanar with the second side wall of the second transition duct.

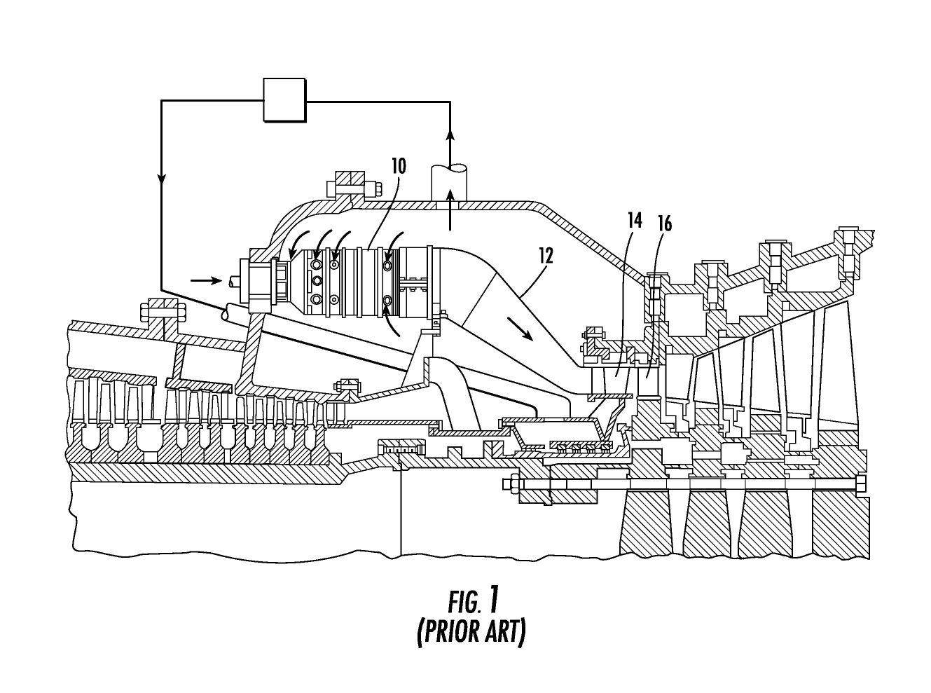

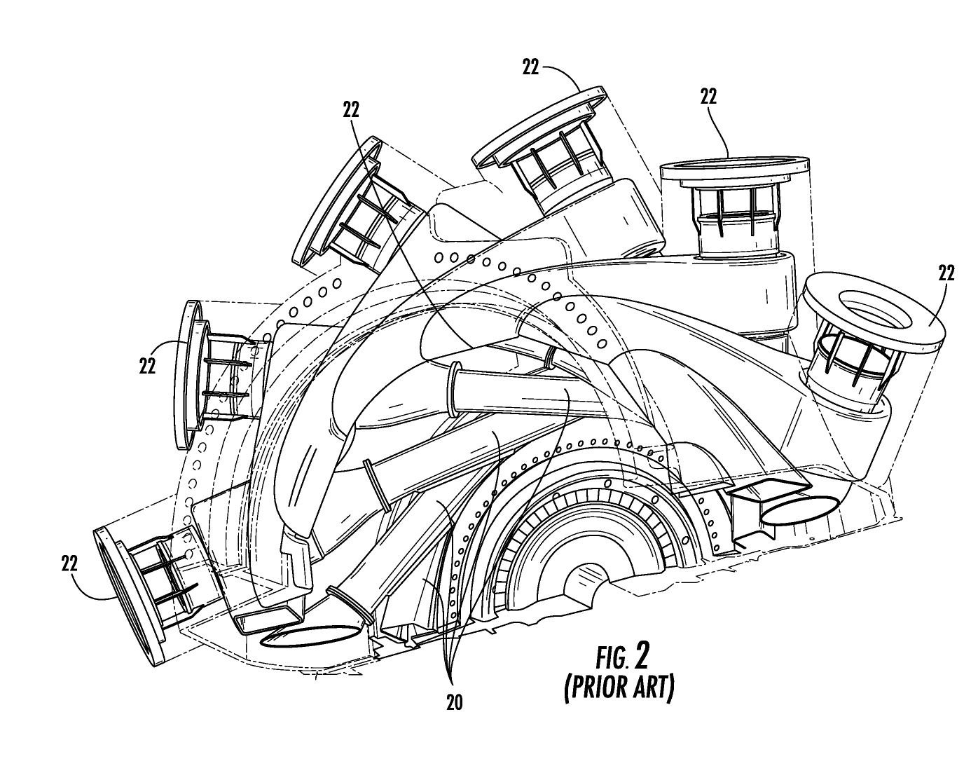

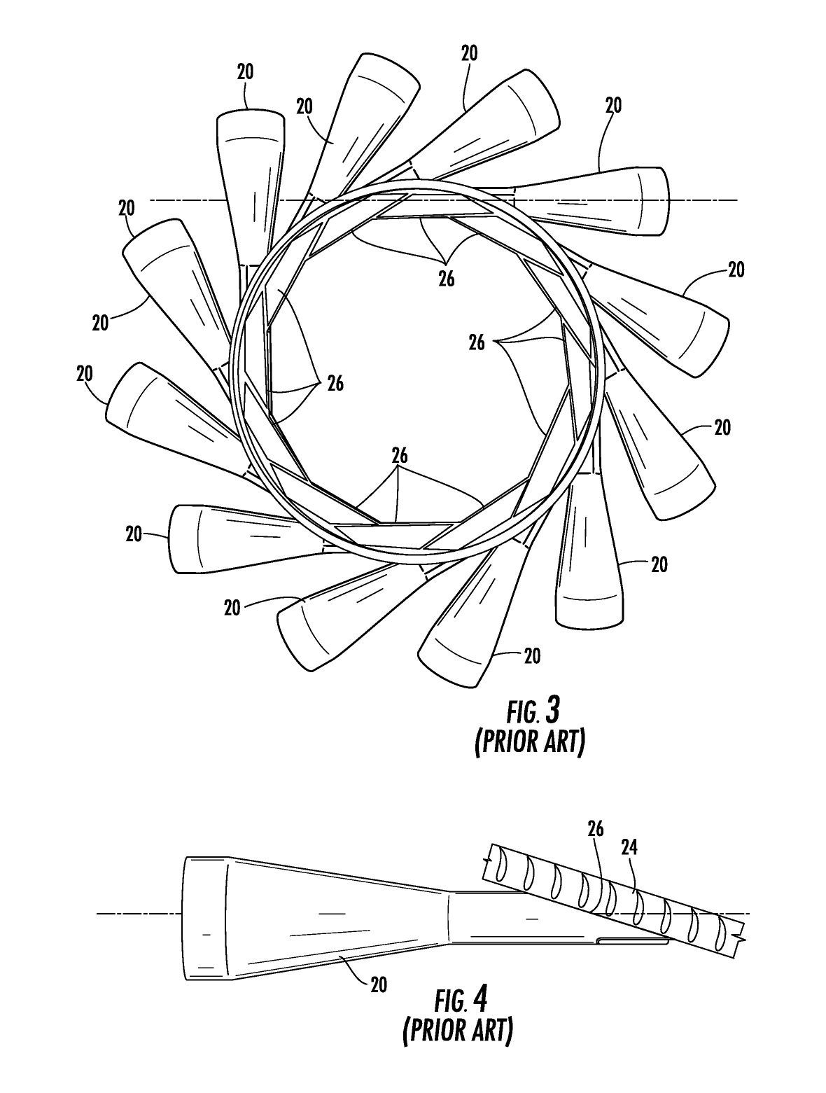

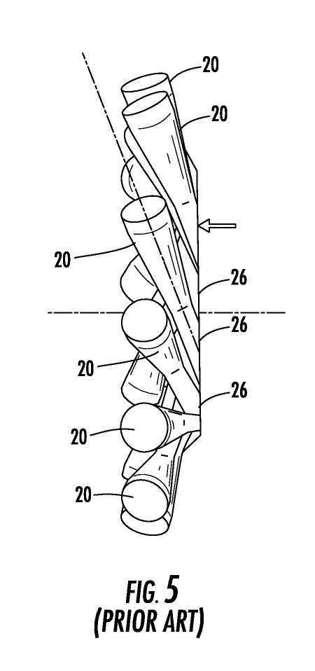

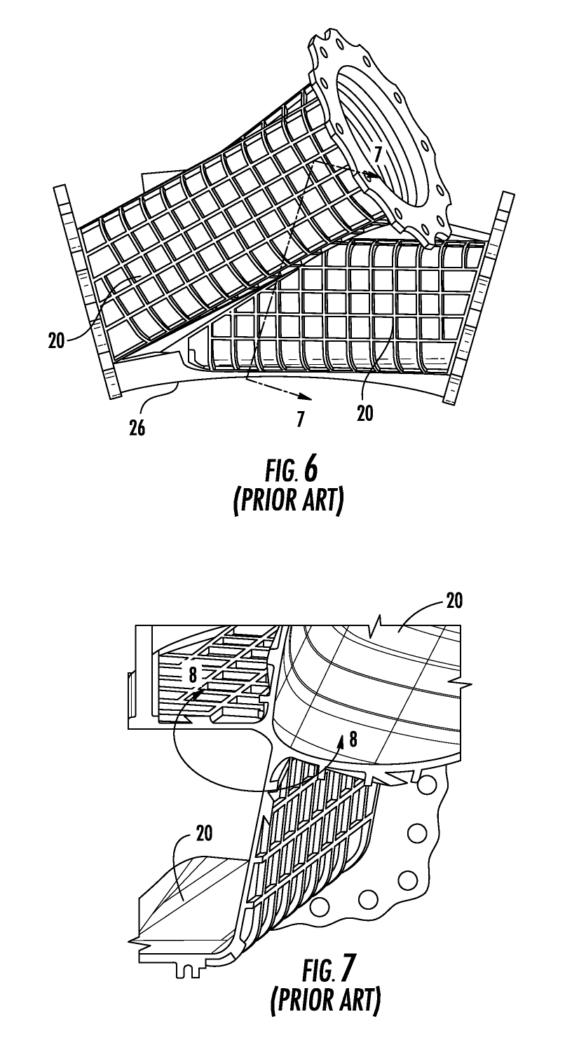

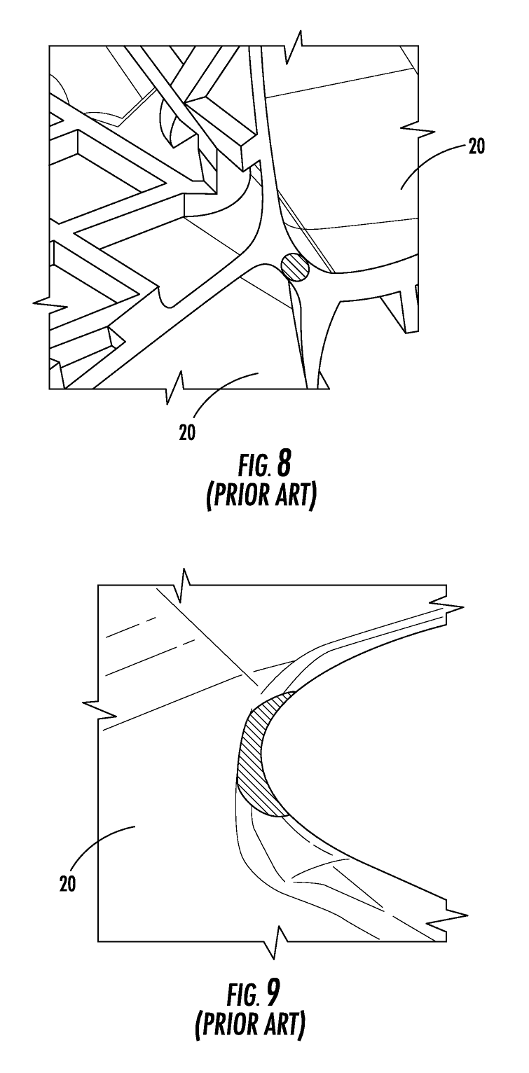

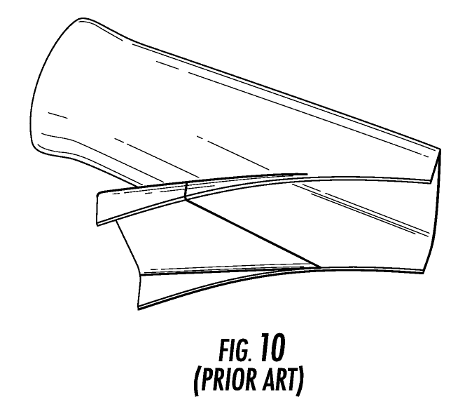

### DETAILED DESCRIPTION OF EMBODIMENTS OF THE INVENTION

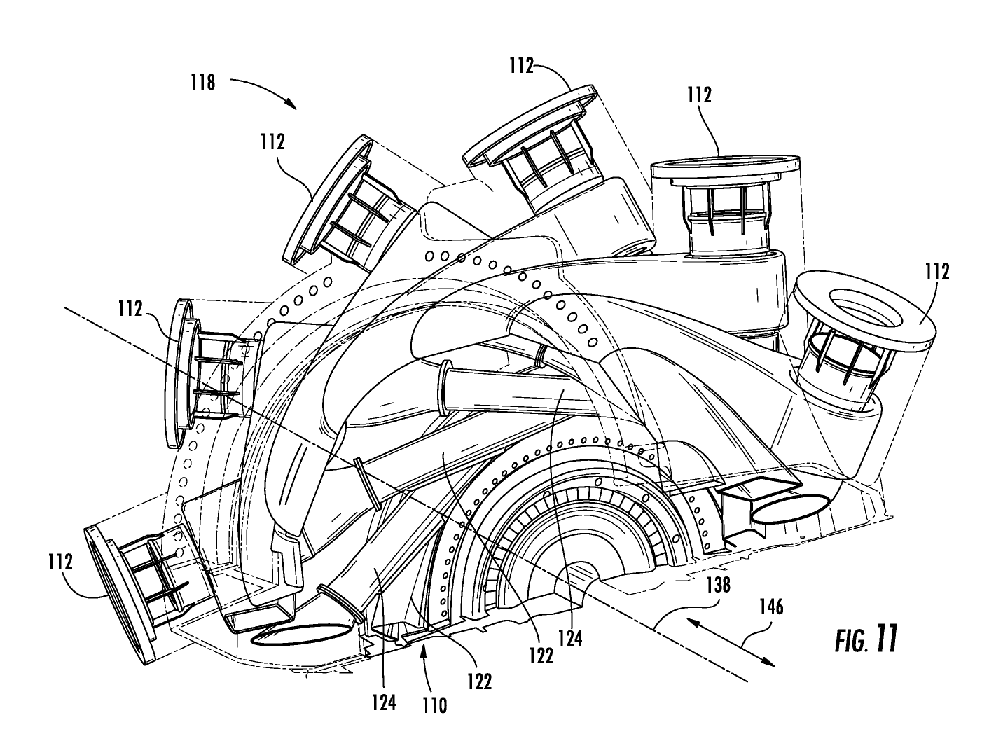

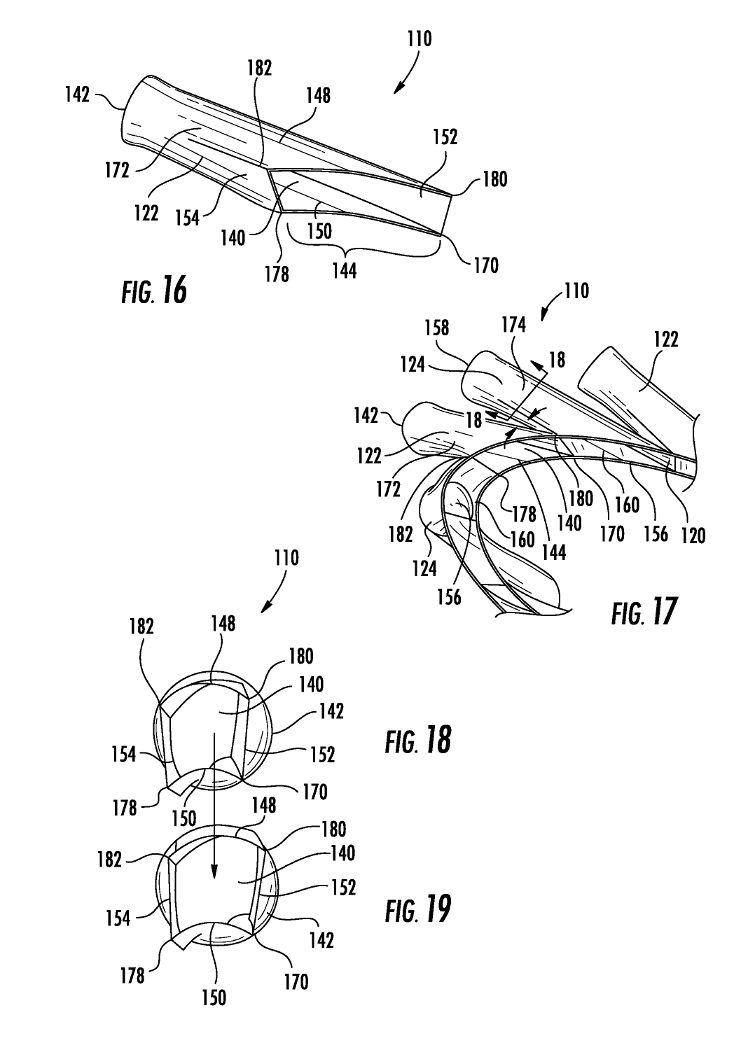

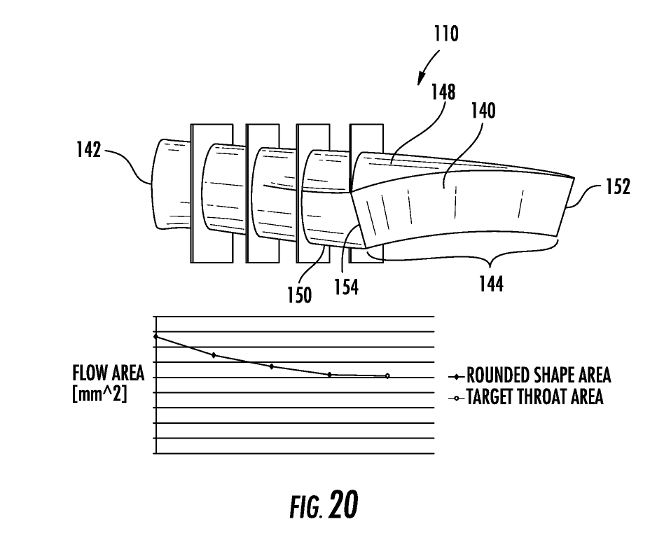

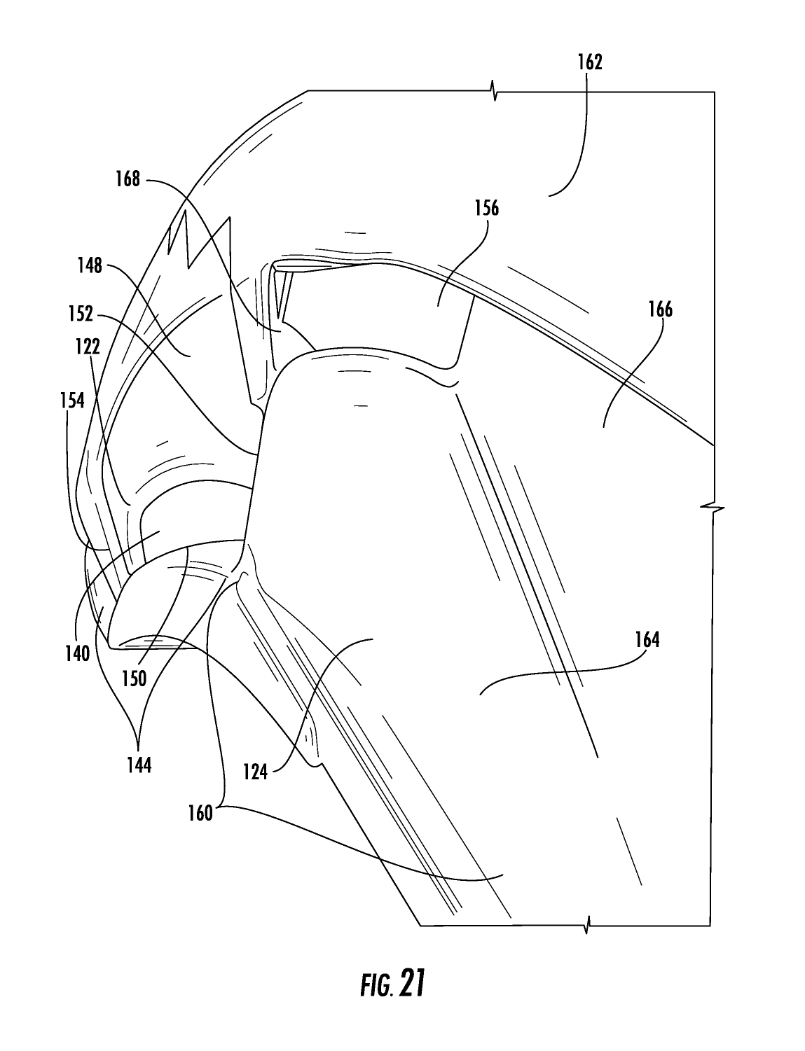

As shown in FIGS. 11-21, a transition duct system 110 for routing a combustion exhaust gas flow from a combustor 112 to a first stage 114 of a turbine section 116 in a combustion turbine engine 118 is disclosed, whereby the system 110 imparts a circumferential vector to the combustion exhaust gases expelled from the system 110, thereby negating the need for a conventional row one vane assembly. The transition duct system 110 may include a robust converging flow joint 120 between adjacent transition ducts 122, 124 within the system 110 such that adjacent transition sections 122, 124 may be adjoined to each other via an intersection 126 forming a linear edge 128 which provides for a strong robust intersection between the adjacent transition sections 122, 124. In at least one embodiment, the linear edge 128 at the intersection 126 may be within 10 degrees of being orthogonal to an inner edge 130 of the transition sections 122, 124 at the intersection 126, as shown in FIGS. 14 and 150.

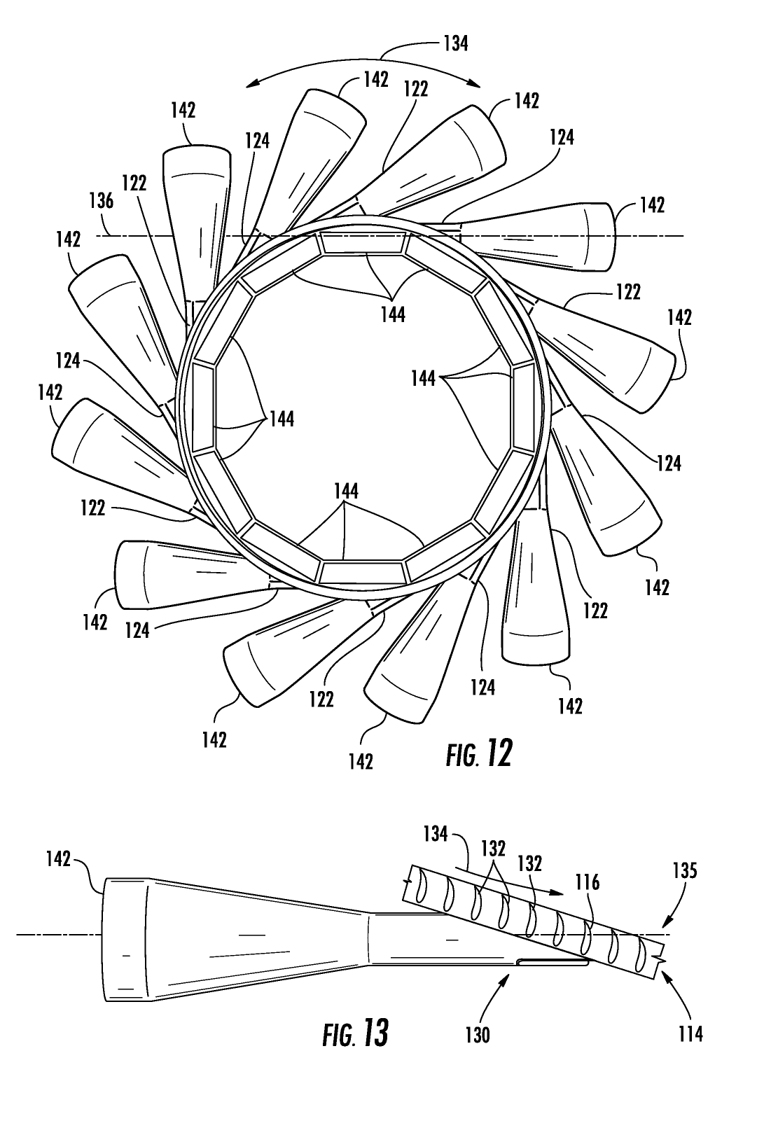

In at least one embodiment, as shown in FIGS. 111-13, the transition duct system 110 may be configured to route gas flow in a combustion turbine subsystem 130 that includes a first stage blade array 114 having a plurality of blades 132 extending in a radial direction from a rotor assembly 135 for rotation in a circumferential direction 134, said circumferential direction having a tangential direction component 136, an axis 138 of the rotor assembly 135 defining a longitudinal direction 134, and one or more combustors 138 located longitudinally upstream of the first stage blade array 114 and located radially outboard of the first stage blade array 114. The transition duct system 110 may include a plurality of transition sections 122, 124 that impart a circumferential vector upon the combustion exhaust gases flowing downstream through the transitions 122, 124, thereby eliminating the need for a row one vane assembly. In at least one embodiment, as shown in FIGS. 14-17, a first transition duct body 122 may have an internal passage 140 extending between an inlet 142 and an outlet 144. The outlet 144 may be offset from the inlet 142 in the longitudinal direction 146 and the tangential direction 136. The outlet 144 may be formed from a radially outer side 148 generally opposite to a radially inner side 150. The radially outer and inner sides 148, 150 may be coupled together with opposed first and second side walls 152, 154.

The transition duct system 110 may include one or more second transition duct bodies 124 having an internal passage 156 extending between an inlet 158 and an outlet 160. The outlet 160 may be offset from the inlet 158 in the longitudinal direction 146 and the tangential direction 136. The outlet 160 may be formed from a radially outer side 162 generally opposite to a radially inner side 164. The radially outer and inner sides 162, 164 may be coupled together with opposed first and second side walls 166, 168. The first side wall 166 of the first transition duct body 122 may terminate at an intersection 126 with the second side wall 168 of the second transition duct body 124. The intersection 126 may form a linear edge 128 that is robust and capable of handling thermal stresses encountered by converging flow joint 120 at the linear edge 128.

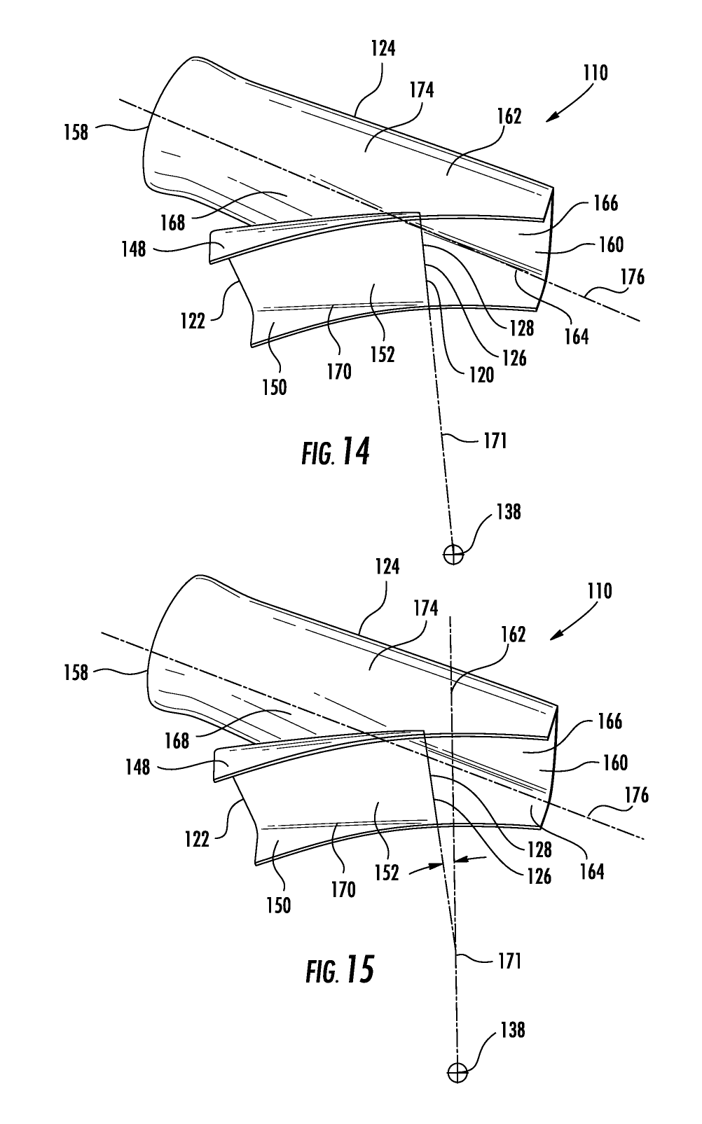

In at least one embodiment, as shown in FIG. 15, the intersection 126 may form a linear edge 128 that is offset from a line 171 extending radially outward from the axis 138 of the rotor assembly 135 defining a longitudinal direction 146 less than 35 degrees when viewed upstream along the axis 138 of the rotor assembly 135 defining the longitudinal direction 146. In another embodiment, the linear edge 128 may be offset from the line 171 extending radially outward from the axis 138 of the rotor assembly 135 defining the longitudinal direction 146 less than 10 degrees when viewed upstream along the axis 138. In yet another embodiment, as shown in FIG. 14, the intersection 126 may form a linear edge 128 that is aligned with the line 171 extending radially outward from the axis 138 of the rotor assembly 135 defining the longitudinal direction. The linear edge 128 may extend orthogonally radially outward from an intersection 170 created between the first side wall 152 of the first transition duct body 122 and the radially inner side 150 of the first transition duct body 122. In at least one embodiment, as shown in FIG. 21, the first side wall 152 of the first transition duct body 122 and the second side wall 168 of the second transition duct body 124 may be coplanar at the linear edge 128 formed at the intersection 170 between first side wall 152 of the first transition duct body 122 and the second side wall 154 of the second transition duct body 124.

The first side wall 152 of the first transition duct body 122 and the second side wall 154 of the second transition duct body 124, when viewed radially inward and orthogonal to the axis 138 of the rotor assembly 135 defining the longitudinal direction 146, may be positioned nonorthogonal to each other and, in at least one embodiment, aligned with each other. In at least one embodiment, as shown in

FIG. 17 from a different angle, the first side wall 152 of the first transition duct body 122 and the second side wall 154 of the second transition duct body 124, when viewed radially inward and orthogonal to the axis 138 of the rotor assembly 135 defining the longitudinal direction 146, may be offset less than 15 degrees from each other. In another embodiment, the first side wall 152 of the first transition duct body 122 and the second side wall 154 of the second transition duct body 124, may be offset less than 5 degrees from each other.

As shown in FIGS. 14 and 15, the radially inner side 150 of the first transition duct body 122 may intersect with the radially inner side 164 of the second transition duct 124 body at the linear edge 128 at the intersection 126 between the first side wall 152 of the first transition duct body 122 and the second side wall 168 of the second transition duct body 124.

In at least one embodiment, the inlet 142, 158 of the first or second transition duct 122, 124, or both may be cylindrical. The transition duct body 172, 174 may transition from a generally cylindrical inlet 142, 158 to a four sided outlet 144, 160.

The outlet 144, 160 may be formed from a curved radially inner side 150, 164, a curved radially outer side 148, 162, a radially extending, linear first side wall 152,166 and a radially extending, linear second side wall 154, 168. The outlet 144, 160 may be nonorthogonal and nonparallel to the inlet 142, 158 when viewed radially inward and generally orthogonal to the axis 138.

The transition duct system 110 is not limited to a particular configuration of the transition duct body 172, 174 but may have any appropriate configuration enabling forming of a robust intersection 126 formed from the linear edge 128. As such, the configuration of the transition duct body 172, 174 between the inlets 142, 158 and the outlets 144, 160 may have any appropriate configuration, confined only by the optimization targets of the design, which may include, but are not limited to being, guide points along the transition duct body 172, 174 to establish a desired throat area within the transition duct body 172, 174, control clearance between adjacent ducts, minimize inflection points along the transition duct body 172, 174, and achieve a smooth, streamwise surface curvature within the transition duct body 172, 174.

In at least one embodiment, the radially inner side 150, 164 may change orientations between the inlet 142, 158 and outlet 144, 160. The radially inner side 150, 164 may change orientations between the inlet 142, 158 and outlet 144, 160. The radially inner side 150, 164 may be curved around a longitudinal axis 176 of the transition duct body 122, 124 at a location between the outlet 144, 160 and inlet 142, 158. The intersection 170 between the radially inner side 150, 164 and the first side wall 152, 166 may be curved. The intersection 178 between the radially inner side 150, 164 and the second side wall 154, 168 may be curved.

Similarly, the radially outer side 148, 162 may change orientations between the inlet 142, 158 and outlet 144, 160. The radially outer side 148 may change orientations between the inlet 142, 158 and outlet 144, 160. The radially outer side 148, 162 is curved around a longitudinal axis 176 of the transition duct body 122, 124 at a location between the outlet 144, 160 and inlet 142, 158. The intersection 180 between the radially outer side 148, 162 and the first side wall 152, 166 may be curved. The intersection 182 between the radially outer side 148, 162 and the second side wall 154, 168 may be curved.

During operation, hot combustor gases flow from a combustor 112 into inlets 142, 158 of the transitions 122, 124. The gases are directed through the internal passages 140, 156. The position of the transition duct 122, 124 is such that gases are directed through the inlet 142, 158, the transition duct bodies, 172, 174, and are expelled out of the outlets 144, 160. The gases are expelled at a proper orientation relative to the turbine blades such that the gases are directed into the turbine blades in correct orientation without need of row one turbine vanes to alter the flow of the gases. Thus, energy is not lost through use of row one turbine vanes.

The foregoing is provided for purposes of illustrating, explaining, and describing embodiments of this invention. Modifications and adaptations to these embodiments will be apparent to those skilled in the art and may be made without departing from the scope or spirit of this invention.

1-13. (canceled)

14. A transition duct system for routing gas flow in a combustion turbine subsystem that includes a first stage blade array having a plurality of blades extending in a radial direction from a rotor assembly for rotation in a circumferential direction, said circumferential direction having a tangential direction component, an axis of the rotor assembly defining a longitudinal direction, and at least one combustor located longitudinally upstream of the first stage blade array and located radially outboard of the first stage blade array, said transition duct system, comprising:
a first transition duct body having an internal passage extending between an inlet and an outlet;
wherein the outlet is offset from the inlet in the longitudinal direction and the tangential direction;
wherein the outlet is formed from a radially outer side generally opposite to a radially inner side, and the radially outer and inner sides are coupled together with opposed first and second side walls;
a second transition duct body having an internal passage extending between an inlet and an outlet;
wherein the outlet is offset from the inlet in the longitudinal direction and the tangential direction;
wherein the outlet is formed from a radially outer side generally opposite to a radially inner side, and the radially outer and inner sides are coupled together with opposed first and second side walls; and
wherein the first side wall of the first transition duct body terminates at an intersection with the second side wall of the second transition duct body, wherein the intersection forms a linear edge that is offset from a line extending radially outward from the axis of the rotor assembly defining a longitudinal direction less than 35 degrees when viewed upstream along the axis of the rotor assembly defining a longitudinal direction.

15. The transition duct system of claim 14, wherein the intersection between the first side wall of the first transition duct body and the second side wall of the second transition duct body forms the linear edge that is offset from the line extending radially outward from the axis of the rotor assembly defining a longitudinal direction less than 10 degrees when viewed upstream along the axis of the rotor assembly defining a longitudinal direction.

16. The transition duct system of claim 14, wherein the intersection between the first side wall of the first transition duct body and the second side wall of the second transition duct body forms the linear edge aligned with the line extending radially outward from the axis of the rotor assembly defining a longitudinal direction.

17. The transition duct system of claim 14, wherein the intersection between the first side wall of the first transition duct body and the second side wall of the second transition duct body forms the linear edge extending orthogonally radially outward from an intersection created between the first side wall of the first transition duct body and the radially inner side of the first transition duct body.

18. The transition duct system of claim 14, wherein the first side wall of the first transition duct body and the second side wall of the second transition duct body are coplanar at the linear edge formed at the intersection between first side wall of the first transition duct body and the second side wall of the second transition duct body.

19. The transition duct system of claim 14, wherein the first side wall of the first transition duct body and the second side wall of the second transition duct body, when viewed radially inward and orthogonal to the axis of the rotor assembly defining the longitudinal direction, are offset less than 15 degrees from each other.

20. The transition duct system of claim 14, wherein the first side wall of the first transition duct body and the second side wall of the second transition duct body, when viewed radially inward and orthogonal to the axis of the rotor assembly defining the longitudinal direction, are offset less than 5 degrees from each other.

21. The transition duct system of claim 14, wherein the radially inner side of the first transition duct body intersects with the radially inner side of the second transition duct body at the linear edge at the intersection between the first side wall of the first transition duct body and the second side wall of the second transition duct body.

22. The transition duct system of claim 4, wherein the inlet of the first transition duct body is cylindrical and wherein the first transition duct body transitions from a generally cylindrical inlet to a four sided outlet.

23. The transition duct system of claim 14, wherein the outlet of the first transition duct body is formed from a curved radially inner side, a curved radially outer side, a radially extending, linear first side wall and a radially extending, linear second side wall.

25. The transition duct system of claim 14, wherein the outlet of the first transition duct body is nonorthogonal and nonparallel to the inlet.

26. The transition duct system of claim 14, wherein the radially inner side of the first transition duct body changes orientations between the inlet and outlet.

27. The transition duct system of claim 14, wherein the radially outer side of the first transition duct body changes orientations between the inlet and outlet.

28. A transition duct system for routing gas flow in a combustion turbine subsystem that includes a first stage blade array having a plurality of blades extending in a radial direction from a rotor assembly for rotation in a circumferential direction, said circumferential direction having a tangential direction component, an axis of the rotor assembly defining a longitudinal direction, and at least one combustor located longitudinally upstream of the first stage blade array and located radially outboard of the first stage blade array, said transition duct system, comprising:
a first transition duct body having an internal passage extending between an inlet and an outlet;
wherein the outlet is offset from the inlet in the longitudinal direction and the tangential direction;
wherein the outlet is formed from a radially outer side generally opposite to a radially inner side, and the radially outer and inner sides are coupled together with opposed first and second side walls;
a second transition duct body having an internal passage extending between an inlet and an outlet;
wherein the outlet is offset from the inlet in the longitudinal direction and the tangential direction;
wherein the outlet is formed from a radially outer side generally opposite to a radially inner side, and the radially outer and inner sides are coupled together with opposed first and second side walls;
wherein the first side wall of the first transition duct body terminates at an intersection with the second side wall of the second transition duct body, wherein the intersection forms a linear edge that is offset from a line extending radially outward from the axis of the rotor assembly defining a longitudinal direction less than 10 degrees when viewed upstream along the axis of the rotor assembly defining a longitudinal direction; and
wherein the radially inner side of the first transition duct body intersects with the radially inner side of the second transition duct body at the linear edge at the intersection between the first side wall of the first transition duct body and the second side wall of the second transition duct body.

29. The transition duct system of claim 28, wherein the intersection between the first side wall of the first transition duct body and the second side wall of the second transition duct body forms the linear edge aligned with the line extending radially outward from the axis of the rotor assembly defining a longitudinal direction.

30. The transition duct system of claim 28, wherein the intersection between the first side wall of the first transition duct body and the second side wall of the second transition duct body forms the linear edge extending orthogonally radially outward from an intersection created between the first side wall of the first transition duct body and the radially inner side of the first transition duct body.

31. The transition duct system of claim 28, wherein the first side wall of the first transition duct body and the second side wall of the second transition duct body are coplanar at the linear edge formed at the intersection between first side wall of the first transition duct body and the second side wall of the second transition duct body.

32. The transition duct system of claim 28, wherein the first side wall of the first transition duct body and the second side wall of the second transition duct body, when viewed radially inward and orthogonal to the axis of the rotor assembly defining the longitudinal direction, are offset less than 5 degrees from each other.

33. A transition duct system for routing gas flow in a combustion turbine subsystem that includes a first stage blade array having a plurality of blades extending in a radial direction from a rotor assembly for rotation in a circumferential direction, said circumferential direction having a tangential direction component, an axis of the rotor assembly defining a longitudinal direction, and at least one combustor located longitudinally upstream of the first stage blade array and located radially outboard of the first stage blade array, said transition duct system, comprising:
a first transition duct body having an internal passage extending between an inlet and an outlet;
wherein the outlet is offset from the inlet in the longitudinal direction and the tangential direction;
wherein the outlet is formed from a radially outer side generally opposite to a radially inner side, and the radially outer and inner sides are coupled together with opposed first and second side walls;
a second transition duct body having an internal passage extending between an inlet and an outlet;
wherein the outlet is offset from the inlet in the longitudinal direction and the tangential direction;
wherein the outlet is formed from a radially outer side generally opposite to a radially inner side, and the radially outer and inner sides are coupled together with opposed first and second side walls; and
wherein the first side wall of the first transition duct body terminates at an intersection with the second side wall of the second transition duct body, wherein the intersection forms a linear edge that is offset from a line extending radially outward from the axis of the rotor assembly defining a longitudinal direction less than 10 degrees when viewed upstream along the axis of the rotor assembly defining a longitudinal direction;
wherein the radially inner side of the first transition duct body intersects with the radially inner side of the second transition duct body at the linear edge at the intersection between the first side wall of the first transition duct body and the second side wall of the second transition duct body;
wherein the first side wall of the first transition duct body and the second side wall of the second transition duct body, when viewed radially inward and orthogonal to the axis of the rotor assembly defining the longitudinal direction, are offset less than 15 degrees from each other.

34. The transition duct system of claim 33, wherein the intersection between the first side wall of the first transition duct body and the second side wall of the second transition duct body forms the linear edge aligned with the line extending radially outward from the axis of the rotor assembly defining a longitudinal direction.
